(19) United States
(12) Patent Application Publication
(10) Pub. No.: US 2024/0239038 A1
(43) Pub. Date: Jul. 18, 2024

(54) STEREOLITHOGRAPHY APPARATUS AND STEREOLITHOGRAPHY METHOD

(71) Applicants: SHASHIN KAGAKU CO., LTD., Kyoto (JP); SK Fine Co., Ltd., Shiga (JP)

(72) Inventors: Tetsuo HOUKI, Kyoto-shi, Kyoto (JP); Tadakatsu ASANO, Kusatsu-shi, Shiga (JP)

(21) Appl. No.: 18/561,663

(22) PCT Filed: Mar. 18, 2022
(86) PCT No.: PCT/JP2022/012916

§ 371 Date: Nov. 16, 2023

(30) Foreign Application Priority Data
Jul. 8, 2021 (JP) 2021-113730

(51) Int. Cl. B29C 64/124; B29C 64/194; B29C 64/245; B29C 64/336; B29C 64/35; B33Y 10/00; B33Y 30/00

(52) U.S. Cl. CPC B29C 64/124; B29C 64/194; B29C 64/245; B29C 64/336; B29C 64/35; B33Y 10/00; B33Y 30/00

(57) ABSTRACT

A first pre-exposure material layer is formed by drawing and spreading of a first material, a first post-exposure material layer including one or a plurality of first exposed portions is formed by exposure of the first pre-exposure material layer, and one or a plurality of first cured portions remain by removal of one or a plurality of first unexposed portions from the first post-exposure material layer. Next, a second pre-exposure material layer that is in contact with the one or plurality of first cured portions is formed by drawing and spreading of a second material, a second post-exposure material layer including one or a plurality of exposed portions is formed by exposure of the second pre-exposure material layer, and one or a plurality of second cured portions remain by removal of one or a plurality of second unexposed portions from the second post-exposure material layer.

### TECHNICAL FIELD

The present invention relates to a stereolithography apparatus and a stereolithography method.

### BACKGROUND ART

Patent Document 1 describes a method and an apparatus for manufacturing a three-dimensional object made of a plurality of materials. In the method and apparatus of Patent Document 1, a layer of ceramic paste is deposited on a work tray. The deposited layer is polymerized by application of a laser beam. Next, a plurality of concave portions are formed in a cured layer by laser processing. Thereafter, a photocurable composition is deposited in the plurality of concave portions with use of a nozzle. The deposited layer is polymerized by application of a laser beam. Thus, a layer made of a plurality of materials is formed.

On the other hand, Patent Document 2 describes an additive manufacturing apparatus that manufactures an object with use of a fused deposition modeling (FDM) method. With the FDM method, a fabrication material containing a thermoplastic-resin is fused to be semi-liquefied and then discharged to a predetermined position based on 3D data of a three-dimensional object to be desirably manufactured, whereby a fabrication layer is formed. A three-dimensional object can be manufactured by repetition of stacking of the fabrication layers. In the additive manufacturing apparatus of Patent Document 2, a first discharge nozzle and a second discharge nozzle that melt and discharge a solid material are provided.
[Patent Document 1] JP 2019-34552 A
[Patent Document 2] JP 2020-146927 A

### SUMMARY OF INVENTION

### Technical Problem

However, in the method and apparatus of Patent Document 1, it is necessary to accurately control the position of a nozzle in order to cause a photocurable composition to be deposited in each of the plurality of concave portions. Therefore, complicated control of the nozzle is required.

On the other hand, in the FDM method described in Patent Document 2, a fabrication layer is formed in a predetermined shape by discharge of a fused fabrication material from the nozzle to the predetermined position. Because the fused material discharged from the nozzle is liquid having viscosity, it is difficult to finely and highly precisely control the fused material. Therefore, it is difficult to form the fabrication layer in a precise shape.

An object of the present invention is to provide a stereolithography apparatus capable of highly precisely manufacturing a three-dimensional object formed of a plurality of materials without complicating control.

### Solution to Problem

(1) A stereolithography apparatus according to one aspect of the present invention includes a manufacturing table that has a manufacturing surface, a supplier that selectively supplies a first material which is a photocurable material and a second material which is a photocurable material different from the first material, a spreading member that forms a first pre-exposure material layer by drawing and spreading the first material that has been supplied by the supplier and forms a second pre-exposure material layer by drawing and spreading the second material that has been supplied by the supplier, an exposer that forms a first post-exposure material layer including one or a plurality of first exposed portions and one or a plurality of first unexposed portions by exposing the first pre-exposure material layer that has been drawn and spread by the spreading member, and forms a second post-exposure material layer including one or a plurality of second exposed portions and one or a plurality of second unexposed portions by exposing the second pre-exposure material layer that has been drawn and spread by the spreading member, a remover that removes the one or plurality of first unexposed portions and the one or plurality of second unexposed portions from the first and second post-exposure material layers, and a controller, wherein the controller controls the supplier such that the first material is supplied, controls the spreading member such that the first pre-exposure material layer is formed on the manufacturing surface or a cured composition layer formed on the manufacturing surface by spreading of the first material, controls the exposer such that the first post-exposure material layer including the one or plurality of exposed portions is formed by exposure of the first pre-exposure material layer, controls the remover such that the one or plurality of first exposed portions remain as one or a plurality of first cured portions by removal of the one or plurality of first unexposed portions from the first post-exposure material layer, controls the supplier such that the second material is supplied, controls the spreading member such that the second pre-exposure material layer that is in contact with the one or plurality of first cured portions is formed by drawing and spreading of the second material after the one or plurality of first unexposed portions are removed, controls the exposer such that the second post-exposure material layer including the one or plurality of second exposed portions is formed by exposure of the second pre-exposure material layer, and controls the remover such that the one or plurality of second exposed portions remain as one or a plurality of second cured portions by removal of the one or plurality of second unexposed portions from the second post-exposure material layer, and the stereolithography apparatus manufactures an object including the one or plurality of first cured portions and the one or plurality of second cured portions.

In this stereolithography apparatus, the first pre-exposure material layer is formed on the manufacturing surface or the cured composition layer by the spreading member. Next, the first post-exposure material layer including the one or plurality of first exposed portions and the one or plurality of first unexposed portions is formed by the exposer. Thereafter, the one or plurality of first unexposed portions of the first post-exposure material layer are removed by the remover. Thus, the one or plurality of first exposed portions remain as the one or plurality of first cured portions. In this state, the second pre-exposure material layer that is in contact with the one or plurality of first cured portions is formed by the spreading member. Next, the second post-exposure material layer including the one or plurality of second exposed portions and the one or plurality of second unexposed portions is formed by the exposer. Thereafter, the one or plurality of second unexposed portions of the second post-exposure material layer are removed by the remover. Thus, the one or plurality of second exposed portions remain as the one or plurality of second cured portions. In this manner, the object including the one or plurality of first cured portions and the one or plurality of second cured portions is formed.

With this configuration, after the first pre-exposure material layer is formed by drawing and spreading of the first material, the one or plurality of first cured portions are formed by exposure and removal. In this case, the first pre-exposure material layer can be formed by simple control of the spreader, and the one or plurality of first cured portions can be accurately formed in a predetermined shape by control of light. Further, after the second pre-exposure material layer is formed by drawing and spreading of the second material, the one or plurality of second cured portions are formed by exposure and removal. In this case, the second pre-exposure material layer can be formed by simple control of the spreader, and the one or plurality of second cured portions can be accurately formed in a predetermined shape by control of light. As a result, it is possible to highly precisely manufacture a three-dimensional object formed of a plurality of materials without complicating control.
(2) The stereolithography apparatus may further include an auxiliary table provided to be capable of being adjacent to the manufacturing table, and a cleaner that cleans an upper surface of the auxiliary table, wherein the controller may control the supplier such that the first material is supplied to the upper surface of the auxiliary table, may control the spreading member such that the first material on the auxiliary table is continuously drawn and spread from the upper surface of the auxiliary table onto the manufacturing surface or the cured composition layer after the first material is supplied, may control the supplier such that the second material is supplied to the upper surface of the auxiliary table after the first material is drawn and spread, may control the spreading member such that the second material on the auxiliary table is continuously drawn and spread from the upper surface of the auxiliary table onto the manufacturing surface or the cured composition layer after the second material is supplied, and may control the cleaner such that the upper surface of the auxiliary table is cleaned after the first material is drawn and spread and before the second material is supplied.

In this case, with use of the common auxiliary table, the first material can be supplied, the first material can be drawn and spread, the second material can be supplied, and the second material can be drawn and spread. Therefore, complication of the structure of the stereolithography apparatus is reduced, and control of the spreading member is simplified. Further, because the upper surface of the auxiliary table is cleaned by the cleaner after the first material is drawn and spread and before the second material is supplied, the first material and the second material are prevented from being mixed on the auxiliary table.
(3) The stereolithography apparatus may further include an auxiliary table provided to be capable of being adjacent to the manufacturing table, wherein the controller may control the supplier such that the first material is supplied to an upper surface of the auxiliary table, may control the spreading member such that the first material on the auxiliary table is continuously drawn and spread from the upper surface of the auxiliary table onto the manufacturing surface or the cured composition layer after the first material is supplied, and may control the remover such that the upper surface of the auxiliary table is cleaned after the first material is drawn and spread and before the second material is supplied.

In this case, with use of the common auxiliary table, the first material can be supplied, the first material can be drawn and spread, the second material can be supplied, and the second material can be drawn and spread. Therefore, complication of the structure of the stereolithography apparatus is reduced, and control of the spreading member is simplified. Further, because the upper surface of the auxiliary table is cleaned by the remover after the first material is drawn and spread and before the second material is supplied, the first material and the second material are prevented from being mixed on the auxiliary table. Further, because the upper surface of the auxiliary table is cleaned by the remover, it is not necessary to separately provide a configuration for cleaning of the upper surface of the auxiliary table. Therefore, it is possible to reduce the manufacturing cost of the stereolithography apparatus.
(4) The controller may control the spreading member such that the first pre-exposure material layer has a first thickness, and may control the spreading member such that the second pre-exposure material layer has a second thickness larger than the first thickness.

In this case, when the second pre-exposure material layer is formed by drawing and spreading, the spreading member is prevented from interfering with the upper surface of the first post-exposure material layer. Thus, the allowable range of the movement accuracy of the spreading member is relaxed. As a result, it is possible to reduce the cost of the stereolithography apparatus. Further, it is possible to easily form the cured composition layer including the first and second cured portions having different thicknesses.
(5) The spreading member may have a lower end extending in parallel with the manufacturing surface, and the controller may control the spreading member such that the spreading member is moved with a distance from the lower end to the manufacturing surface or an upper surface of the cured composition layer maintained equivalent to the first thickness when the first material is drawn and spread, and may control the spreading member such that the spreading member is moved with a distance from the lower end to the manufacturing surface or the upper surface of the cured composition layer maintained equivalent to the second thickness when the second material is drawn and spread.

In this case, it is possible to easily and accurately form the pre-exposure material layer having the first thickness and the pre-exposure material layer having the second thickness by adjusting the distance between the manufacturing surface or the upper surface of the cured composition layer, and the lower end of the spreading member and moving the spreading member in parallel with the manufacturing surface.
(6) The stereolithography apparatus may further include a shielding member that shields the exposer, wherein the controller may control the shielding member such that the exposer is shielded when the one or plurality of first unexposed portions are removed and when the one or plurality of second unexposed portions are removed.

In this case, even in a case in which the one or plurality of first and second unexposed portions that have been removed are scattered as dust, the dust is prevented from adhering to the exposer. This reduces the frequency of maintenance and cleaning of the exposer.
(7) One of the first and second materials may include an insulating material, and another one of the first and second materials includes a conductive material.

In this case, a three-dimensional object formed of an insulating material and a conductive material can be highly precisely manufactured by simple control.
(8) A stereolithography method according to another aspect of the present invention includes the steps of supplying a first material which is a photocurable material, forming a first pre-exposure material layer on a manufacturing surface or a cured composition layer formed on the manufacturing surface by drawing and spreading the first material layer, forming the first post-exposure material layer including one or a plurality of exposed portions by exposing the first pre-exposure material layer, causing the one or plurality of first exposed portions to remain as one or a plurality of cured portions by removing one or a plurality of first unexposed portions from the first post-exposure material layer, supplying a second material which is a photocurable material different from the first material, forming a second pre-exposure material layer that is in contact with the one or plurality of first cured portions by drawing and spreading the second material after the one or plurality of first unexposed portions are removed, forming a second post-exposure material layer including one or a plurality of second exposed portions by exposing the second pre-exposure material layer, and causing the one or plurality of second exposed portions to remain as one or a plurality of second cured portions by removing one or a plurality of second unexposed portions from the second post-exposure material layer, wherein with the optical manufacturing method, an object that includes the one or plurality of first cured portions and the one or plurality of second cured portions is manufactured.

With this stereolithography method, after the first pre-exposure material layer is formed by drawing and spreading of the first material, the one or plurality of first cured portions are formed by exposure and removal. In this case, the first pre-exposure material layer can be formed by simple control by drawing and spreading, and the one or plurality of first cured portions can be accurately formed in a predetermined shape by control of light. Further, after the second pre-exposure material layer is formed by drawing and spreading of the second material, the one or plurality of second cured portions are formed by exposure and removal. In this case, the second pre-exposure material layer can be formed with the simple control by drawing and spreading, and the one or plurality of second cured portions can be accurately formed in a predetermined shape with control of light. As a result, it is possible to highly precisely manufacture a three-dimensional object formed of a plurality of materials without complicating control.
(9) In regard to the stereolithography method, the step of forming a first pre-exposure material layer may include forming the first pre-exposure material layer such that the first pre-exposure material layer has a first thickness, and the step of forming a second pre-exposure material layer may include forming the second pre-exposure material layer such that the second pre-exposure material layer has a second thickness larger than the first thickness.

In this case, when the second pre-exposure material layer is formed by drawing and spreading of the second material, the spreading member is prevented from interfering with the upper surface of the first post-exposure material layer. Thus, the allowable range of the movement accuracy of the spreading member is relaxed. As a result, it is possible to reduce the cost of the stereolithography apparatus. Further, it is possible to easily form the cured composition layer including the first and second cured portions having different thicknesses.

### Advantageous Effects of Invention

With the present invention, it is possible to highly precisely manufacture a three-dimensional object formed of a plurality of materials without complicating control.

### BRIEF DESCRIPTION OF THE DRAWINGS

FIG. 1 is a schematic perspective view of a stereolithography apparatus according to one embodiment of the present invention.

FIG. 2 is a schematic side view of the stereolithography apparatus of FIG. 1.

FIG. 3 is a flowchart showing the first operation example of the stereolithography apparatus of FIG. 1.

FIG. 4 is a flowchart showing the first operation example of the stereolithography apparatus of FIG. 1.

FIG. 5 is a schematic cross sectional view showing the first operation example of the stereolithography apparatus of FIG. 1.

FIG. 6 is a schematic cross sectional view showing the first operation example of the stereolithography apparatus of FIG. 1.

FIG. 7 is a schematic cross sectional view showing the first operation example of the stereolithography apparatus of FIG. 1.

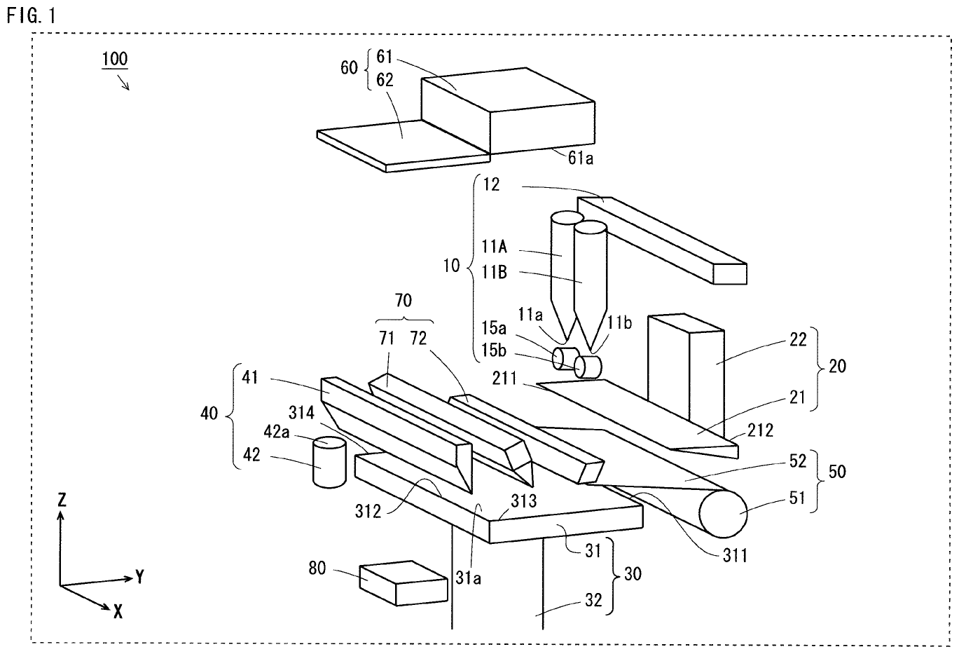

FIG. 6 is a schematic cross sectional view showing the first operation example of the stereolithography apparatus of FIG. 1.

FIG. 9 is a schematic cross sectional view showing the first operation example of the stereolithography apparatus of FIG. 1.

FIG. 10 is a schematic cross sectional view showing the first operation example of the stereolithography apparatus of FIG. 1.

FIG. 11 is a schematic cross sectional view showing the first operation example of the stereolithography apparatus of FIG. 1.

FIG. 12 is a schematic cross sectional view showing the first operation example of the stereolithography apparatus of FIG. 1.

FIG. 13 is a schematic cross sectional view showing the first operation example of the stereolithography apparatus of FIG. 1.

FIG. 14 is a schematic cross sectional view showing the first operation example of the stereolithography apparatus of FIG. 1.

FIG. 15 is a schematic cross sectional view showing the first operation example of the stereolithography apparatus of FIG. 1.

FIG. 16 is a schematic cross sectional view showing the first operation example of the stereolithography apparatus of FIG. 1.

FIG. 17 is a schematic cross sectional view showing part of a second operation example of the stereolithography apparatus of FIG. 1.

FIG. 18 is a schematic cross sectional view showing part of the second operation example of the stereolithography apparatus of FIG. 1.

FIG. 19 is a schematic cross sectional view showing part of the second operation example of the stereolithography apparatus of FIG. 1.

FIG. 20 is a schematic cross sectional view showing part of the second operation example of the stereolithography apparatus of FIG. 1.

FIG. 21 is a schematic cross sectional view showing part of the second operation example of the stereolithography apparatus of FIG. 1.

### DESCRIPTION OF EMBODIMENTS

A stereolithography apparatus and a stereolithography method according to embodiments of the present invention will be described below with reference to the drawings.

### (1) Configuration of Stereolithography Apparatus

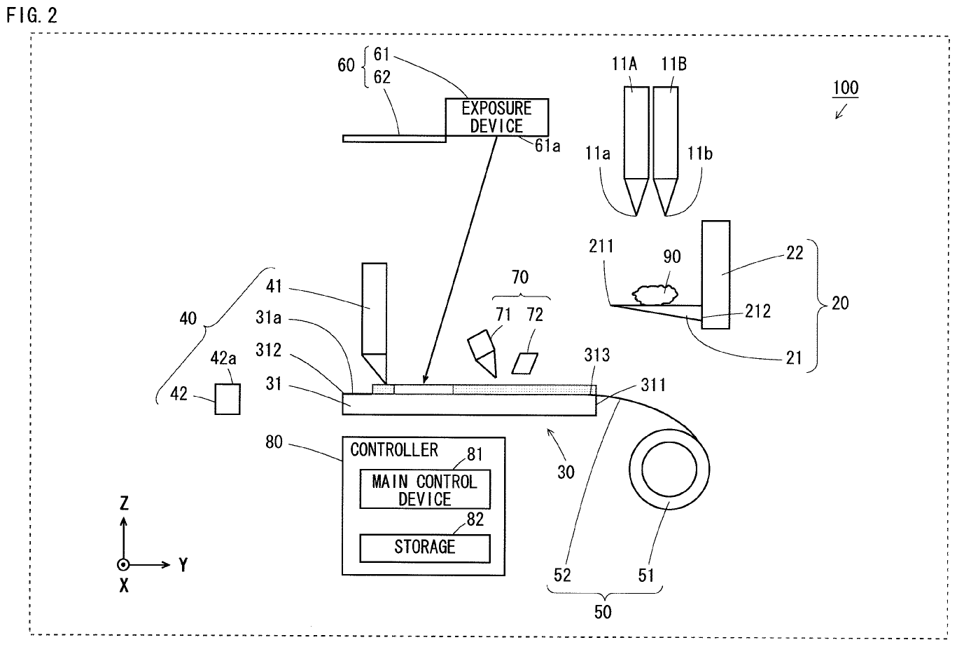

FIG. 1 is a schematic perspective view of the stereolithography apparatus according to one embodiment of the present invention. FIG. 2 is a schematic side view of the stereolithography apparatus 100 of FIG. 1. In FIGS. 1 and 2, as indicated by the arrows, directions orthogonal to each other in a horizontal plane are referred to as an X direction and a Y direction, and a vertical direction is referred to as a Z direction. This also applies to the subsequent diagrams. As shown in FIG. 1, the stereolithography apparatus 100 includes a supplier 10, an auxiliary table unit 20, a manufacturing table unit 30, a recoater unit 40, a cover supply unit 50, an exposer 60, a remover 70 and a controller 80.

The supplier 10 includes a plurality of syringe-type dispensers 11A, 11B, a driving device 12 and cap members 15a, 15b. In the present embodiment, the two dispensers 11A, 11B are provided. Each of the dispensers 11A, 11B has a cylindrical shape extending in the Z direction and stores a photocurable material 90. In the present embodiment, a photocurable composition including insulating ceramic powder (hereinafter referred to as a first material 90A) is stored in the dispenser 11A as the photocurable material 90, and a photocurable composition including conductive powder (metallic powder, for example) (hereinafter referred to as a second material 90B) is stored in the dispenser 11B as the photocurable material 90. In the present embodiment, the insulating ceramic powder is a borosilicate glass ceramic material (alumina), for example, and the conductive powder is powder of silver and palladium that has the weight ratio of 30:70, for example. The photocurable composition may be liquid, semi-liquid or solid having viscosity. The dispensers 11A, 11B include compression devices (not shown), and can respectively regulate the amounts of the first and second materials 90A, 90B to be discharged.

At the tip (the lower ends) of the dispensers 11A, 11B, supply holes 11a, 11b through which the first and second materials 90A, 90B are supplied are respectively formed. The driving device 12 supports the dispensers 11A, 11B above an auxiliary table 21, described below, such that the dispensers 11A, 11B are independently movable in the X direction. Each of the cap members 15a, 15b has a columnar shape rotatable about a rotation axis parallel to the Y direction, and are held in the vicinity of one end portion of the auxiliary table 21 in the X direction by a holding member (not shown). Waiting positions of the dispensers 11A, 11Bb are provided above the cap members 15a, 15b. When the dispensers 11A, 11B are in the waiting positions, the supply holes 11a, 11b of the dispensers 11A, 11B are closed by the outer peripheral surfaces of the cap members 15a, 15b.

The auxiliary table unit 20 includes the auxiliary table (coating table) 21 extending in the X direction and a driving device 22. The auxiliary table 21 is arranged in close proximity to an edge 311 of a manufacturing table 31 of the manufacturing table unit 30, described below, and has edges 211, 212 parallel to the X direction. This auxiliary table 21 is held so as to be movable in the Z direction by the driving device 22. As shown in FIG. 2, on the upper surface of the auxiliary table 21, the photocurable material 90 (the first material 90A and the second material 90B) supplied through the supply hole 11a of the dispenser 11A or the supply hole 11b of the dispenser 11B is deposited.

As shown in FIG. 1, the manufacturing table unit 30 includes the rectangular manufacturing table 31 and a driving device 32. The manufacturing table 31 has a pair of edges 311, 312 parallel to the X direction and another pair of edges 313, 314 parallel to the Y direction, and has an upper surface perpendicular to the Z direction. The upper surface of the manufacturing table 31 is a manufacturing surface 31a on which an object is to be manufactured. This manufacturing table 31 is held to be movable in the Z direction by the driving device 32.

The recoater unit 40 includes a blade-like recoater 41 that extends in the X direction and a cup member 42. The recoater 41 is held by a driving device (not shown) above the manufacturing table 31 to be movable in the Y direction. The recoater 41 is moved from a position above the auxiliary table 21 toward the edge 312 of the manufacturing table 31. Thus, as shown in FIG. 2, the photocurable material 90 (the first material 90A or the second material 90B) deposited on the auxiliary table 21 is drawn and spread on the manufacturing surface 31a of the manufacturing table 31 or on an already formed cured composition layer 95 (see FIGS. 15 and 16, described below). Hereinafter, the photocurable material 90 that has been drawn and spread is referred to as a pre-exposure composition layer.

The cup member 42 has an upper opening 42a and is arranged at a position opposite to the auxiliary table 21 with the manufacturing table 31 interposed therebetween. A waiting position of the recoater 41 is provided in close proximity to the edge 312 of the manufacturing table 31. The cup member 42 is provided such that the upper opening 42a is in close proximity to the recoater 41 being in the waiting position. The cup member 42 is includes an actuator (not shown), for example, and is movable in the X direction. Further, the cup member 42 includes a vacuum pump (not shown), for example, and can suck the first material 90A or the second material 90B adhering to the recoater 41 from the upper opening 42a.

The cover supply unit 50 includes a film roll 51 extending in the X direction. The film roll 51 is provided in close proximity to the edge 311 of the manufacturing table 31. A clear film 52 drawn out from the film roll 51 is arranged as a cover to cover the manufacturing surface 31a of the manufacturing table 31. In the following description, the manufacturing surface 31a covered with the clear film 52 may also be simply referred to as the manufacturing surface 31a.

The exposer 60 includes an exposure device 61 and a shielding member 62. The exposure device 61 is arranged above the manufacturing table 31 and cures the pre-exposure composition layer on the manufacturing surface 31a in a desired shape by exposure. In the present embodiment, the exposure device 61 exposes a region in a predetermined shape of the pre-exposure composition layer by scanning laser light in a desired shape. Thus, the exposed portion having the predetermined shape is cured. In this case, the shape of the exposed portion is formed highly precisely on the order of μm (1 μm to several hundred μm, for example). When the pre-exposure composition layer is exposed, a post-exposure composition layer is formed. The post-exposure composition layer includes one or a plurality of exposed portions and one or a plurality of unexposed portions. The one or plurality of exposed portions are cured to be one or a plurality of cured portions.

The shielding member 62 is provided so as to be capable of shielding an emission surface 61a for laser light of the exposure device 61. The shielding member 62 includes an actuator (not shown), for example, and is movable in the Y direction.

The remover 70 includes an air knife 71 and a sucker 72 extending in the X direction. The remover 70 includes an actuator (not shown), for example, and can move the air knife 71 and the sucker 72 in the Y direction. In the present embodiment, the remover 70 is configured to be movable from the edge 312 of the manufacturing table 31 to a position on the auxiliary table 21 in the Y direction. The air knife 71 includes a compressed air supply device (not shown) to which compressed air is supplied from a blower pump, an air compressor or the like, and is configured to discharge a high-pressure gas. Thus, one or a plurality of unexposed portions (uncured portions) of the photocurable material 90 are blown off. The sucker 72 includes a large-capacity exhaust device (not shown) including a vacuum pump, a blower pump or the like, and is configured to suck the non-exposed portions blown off by the air knife 71. In this state, the air knife 71 and the sucker 72 are moved in the Y direction on the upper surface of the manufacturing table 31, so that the upper surface of the manufacturing surface 31a is cleaned. Further, the remover 70 is moved in the Y direction to a position above the upper surface of the auxiliary table 21, so that the upper surface of the auxiliary table 21 is cleaned. In the present embodiment, the remover 70 also serves as a cleaner that cleans the upper surface of the auxiliary table 21. A cleaner may be provided separately from the remover 70. In this case, the cleaner includes an air knife and a sucker, for example, and is controlled by the controller 80.

The controller 80 controls the operations of the supplier 10, the auxiliary table unit 20, the manufacturing table unit 30, the recoater unit 40, the cover supply unit 50, the exposer 60 and the remover 70, thereby controlling the operation of the stereolithography apparatus 100. The controller 80 includes a main control device 81 and a storage 82. The main control device 81 includes a CPU (Central Processing Unit), for example, and controls various constituent elements of the stereolithography apparatus 100 and performs data processing. The storage 82 includes a semiconductor memory or a hard disc, for example, and stores manufacturing data representing the three-dimensional shape of an object to be manufactured and a control program. The manufacturing data stored in the storage 82 includes a plurality of slice data pieces representing the cross sectional shape in a horizontal direction of each cured composition layer 95 (FIGS. 15 and 16), described below, of an object and the distribution of a plurality of materials in each cured composition layer 95.

In the present embodiment, M sets of slice data pieces are stored. M represents the total number of cured composition layers 95 (FIG. 16), and is an integer equal to 1 or 2 or larger than 2. Each slice data set includes first slice data corresponding to the distribution of the first material 90A and second slice data corresponding to the distribution of the second material 90B. The main control device 81 executes the control program stored in the storage 82, so that various constituent elements of the stereolithography apparatus 100 are controlled by the controller 80.

### (2) First Operation Example of Stereolithography Apparatus

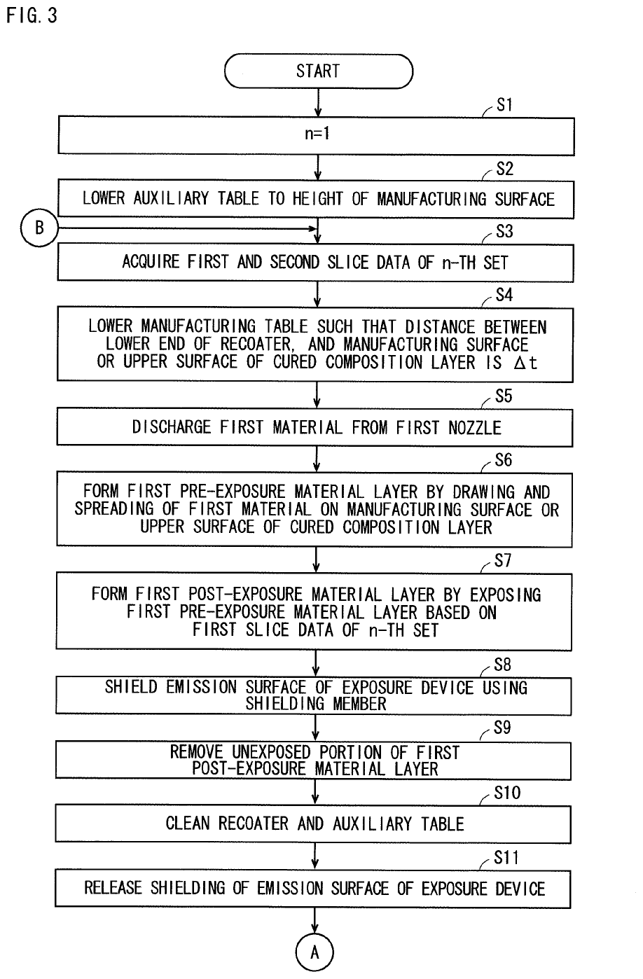

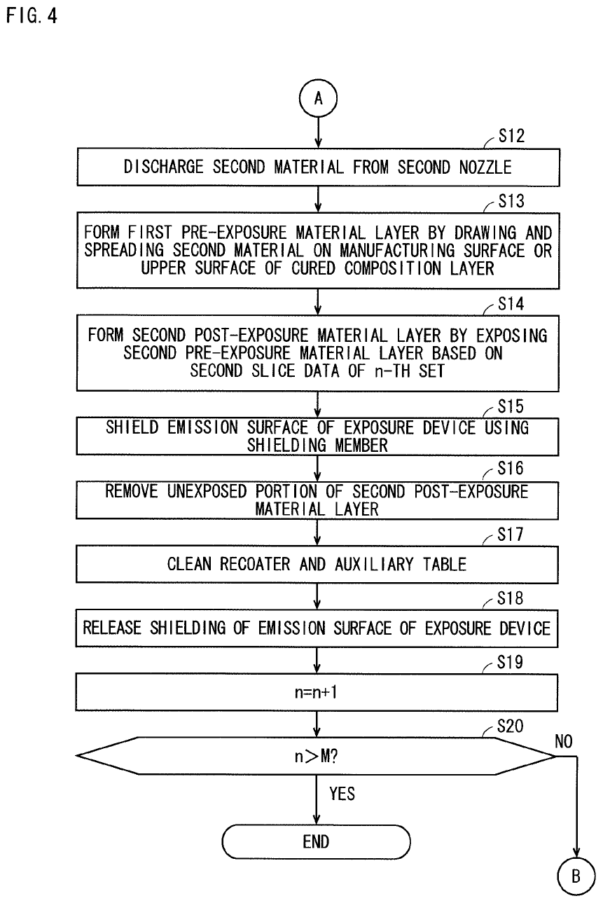

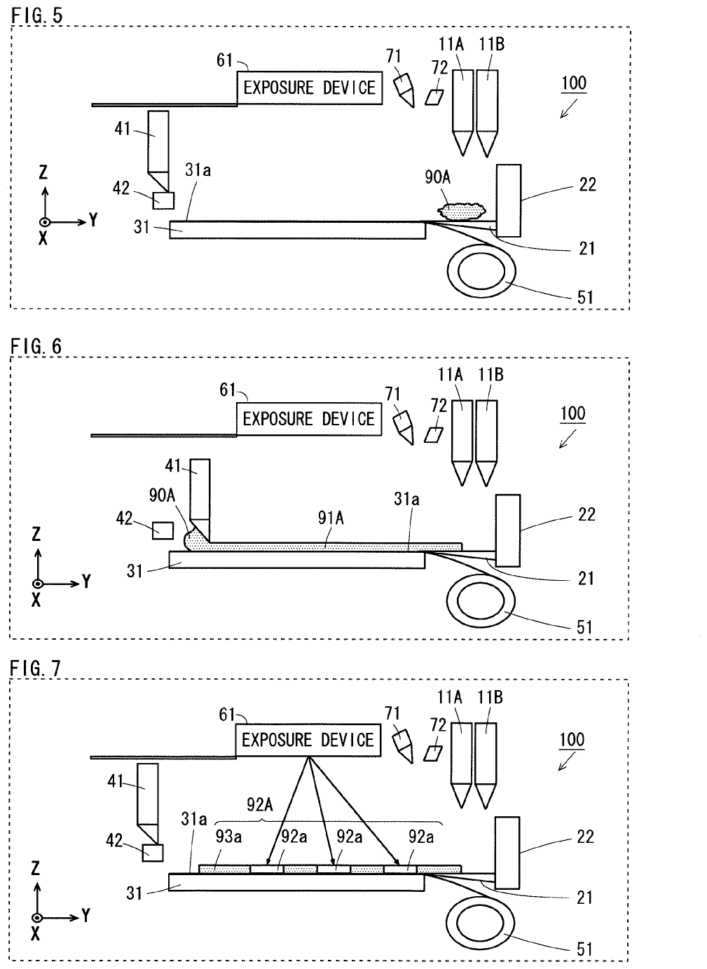

Here, a first operation example of the stereolithography apparatus 100 will be described. FIGS. 3 and 4 are flowcharts showing the first operation example of the stereolithography apparatus 100 of FIG. 1. FIGS. 5 to 16 are schematic cross sectional views showing the first operation example of the stereolithography apparatus 100 of FIG. 1.

First, the main control device 81 sets the value of a variable n to 1 (step S1). Next, as shown in FIG. 5, the auxiliary table 21 is lowered such that the height of the upper surface of the auxiliary table 21 coincides with the height of the manufacturing surface 31a (step S2). Further, the main control device 81 acquires the first and second slice data of the n-th set from the storage 82 (step S3). Further, the manufacturing table 31 is lowered such that the distance between the manufacturing surface 31a or the top cured composition layer 95 which has already been formed, and the lower end of the recoater 41 is Δt (step S4). In a case in which n=1, the manufacturing table 31 is lowered such that the distance between the manufacturing surface 31a and the lower end of the recoater 41 is Δt. In a case in which n=2 to M, the manufacturing table 31 is lowered such that the distance between the upper surface of the (n−1)-th cured composition layer and the lower end of the recoater 41 is Δt.

In this state, as shown in FIG. 5, the dispenser 11A is moved in the X direction while discharging the first material 90A to the upper surface of the auxiliary table 21 (step S5). Thus, the first material 90A is deposited on the upper surface of the auxiliary table 21 so as to extend in the X direction.

Next, as shown in FIG. 6, after the recoater 41 is moved to a position above the upper surface of the auxiliary table 21, the recoater 41 continuously draws and spreads the first material 90A from the upper surface of the auxiliary table 21 onto the manufacturing surface 31a or the upper surface of the cured composition layer 91 (step S6). In a case in which n=1, the recoater 41 continuously draws and spreads the first material 90A from the upper surface of the auxiliary table 21 onto the manufacturing surface 31a. In a case in which n=2 to M, the recoater 41 continuously draws and spreads the first material 90A on the upper surface of the (n−1)-th cured composition layer 95 from the upper surface of the auxiliary table 21. Hereinafter, the first material 90A that has been drawn and spread is referred to as a first pre-exposure material layer 91A. In the present operation example, the first pre-exposure material layer 91A has a first thickness t1. The size of the first thickness t1 is equivalent to the distance Δt.

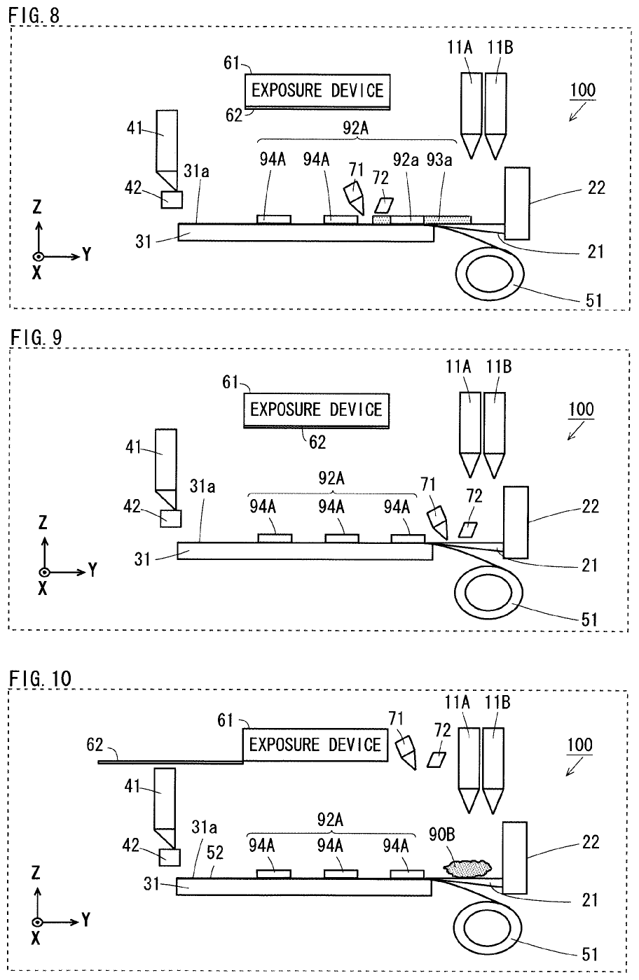

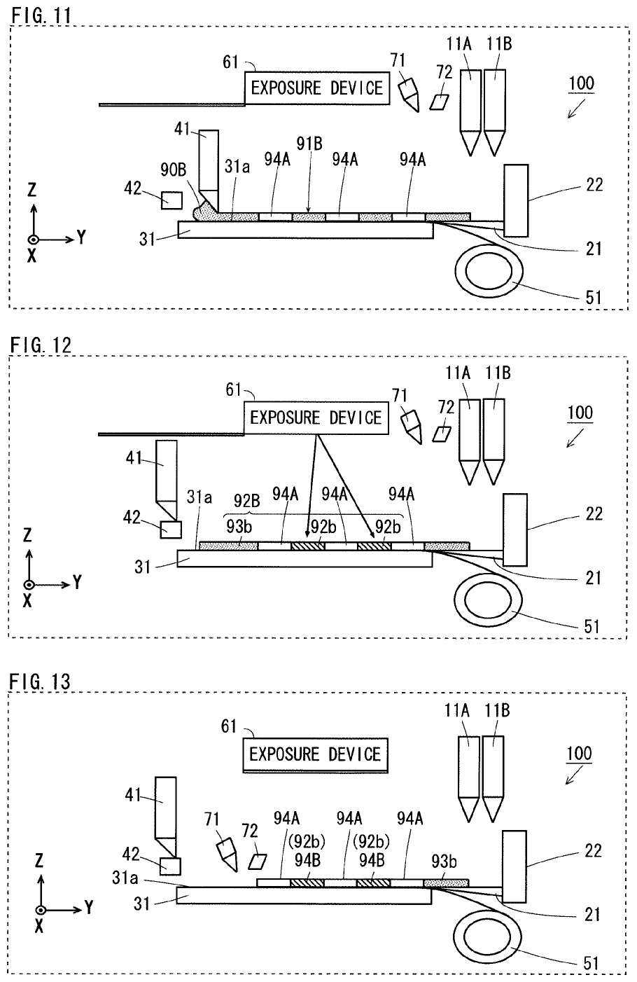

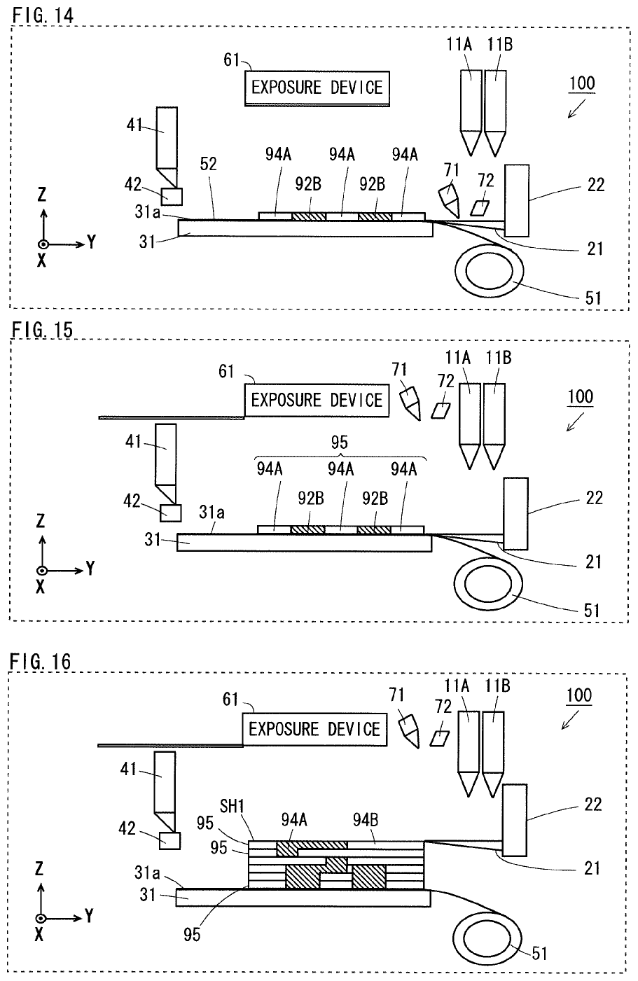

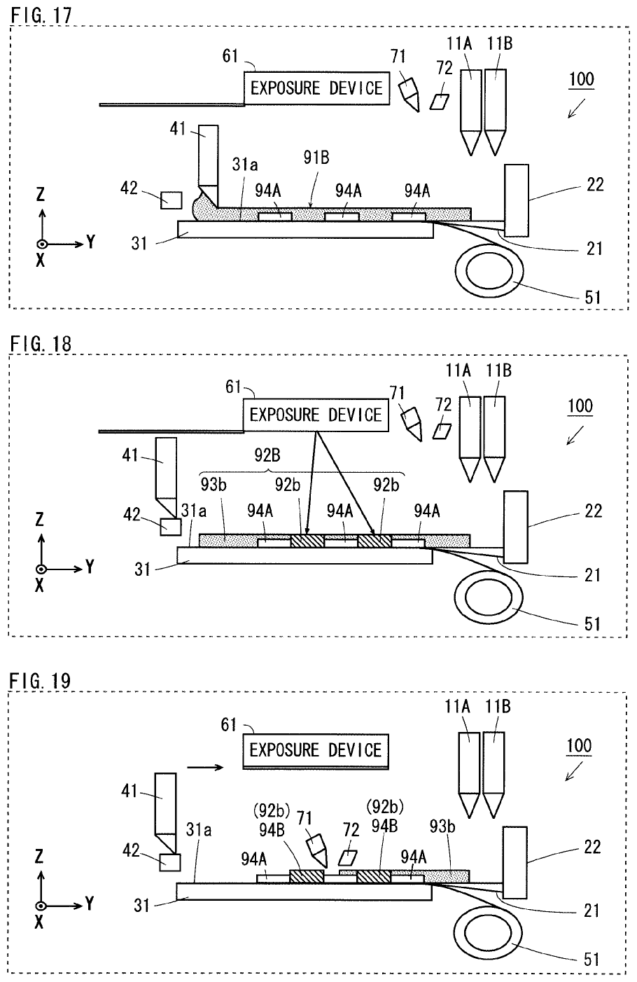

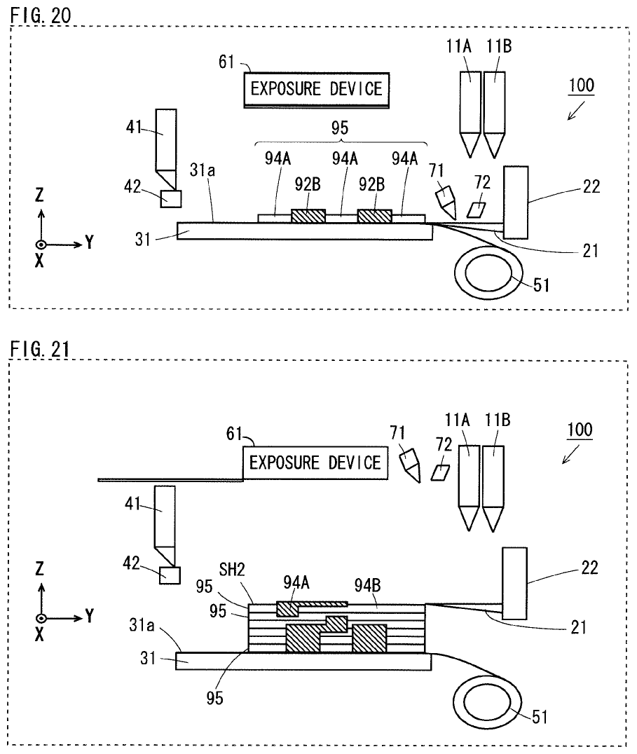

Subsequently, as shown in FIG. 7, the exposure device 61 exposes the first pre-exposure material layer 91A of the n-th set based on the first slice data of the n-th set (step S7). Hereinafter, the first pre-exposure material layer 91A that has been exposed is referred to as a first post-exposure material layer 92A. The first post-exposure material layer 92A includes one or a plurality of first exposed portions 92a that have been exposed and one or a plurality of unexposed portions 93a that have not been exposed. The one or plurality of first exposed portions 92a are cured by exposure.

Next, as shown in FIG. 8, the shielding member 62 shields the emission surface 61a of the exposure device 61 (step S8). In this state, the air knife 71 and the sucker 72 work, and are moved in the Y direction along the upper surface of the first post-exposure material layer 92A on the manufacturing table 31 to a position above the auxiliary table 21 as shown in FIG. 8. Thus, the one or plurality of unexposed portions 93a are removed (step S9). Thus, the one or plurality of first exposed portions 92a remain. Hereinafter, the remaining one or plurality of first exposed portions 92a are referred to as one or a plurality of first cured portions 94A. At this time, an atmosphere in the stereolithography apparatus 100 may be cleaned by an exhaust fan, an air clean filter unit or the like (not shown).

Further, as shown in FIG. 9, the air knife 71 and the sucker 72 clean the auxiliary table 21, and the cup member 42 cleans the recoater 41 (step S10). Next, as shown in FIG. 10, the shielding member 62 releases the shielding of the emission surface 61a of the exposure device 61 (step S11). Thus, the emission surface 61a of the exposure device 61 is uncovered.

Subsequently, the dispenser 11B is moved in the X direction while discharging the second material 90B to the upper surface of the auxiliary table 21 (step S12). Thus, as shown in FIG. 10, the second material 90B is deposited on the upper surface of the auxiliary table 21 so as to extend in the X-direction.

Next, as shown in FIG. 11, after the recoater 41 is moved to a position above the upper surface of the auxiliary table 21, the recoater 41 draws and spreads the second material 90B from the upper surface of the auxiliary table 21 onto the manufacturing surface 31a or the upper surface of the cured composition layer 95 (step S13). In a case in which n=1, the recoater 41 continuously draws and spreads the second material 90B from the upper surface of the auxiliary table 21 onto the manufacturing surface 31a. In a case in which n=2 to M, the recoater 41 continuously draws and spreads the second material 90B on the upper surface of the (n−1)-th cured composition layer 95 from the upper surface of the auxiliary table 21. Hereinafter, the second material 90B that has been drawn and spread is referred to as a second pre-exposure material layer 91B. The second pre-exposure material layer 91B is formed so as to be in contact with the one or plurality of first cured portions 94A. In the present operation example, the second pre-exposure material layer 91B has the first thickness t1.

Subsequently, as shown in FIG. 12, the exposure device 61 exposes the second pre-exposure material layer 91B based on the second slice data of the n-th set piece (step S14). Hereinafter, the second pre-exposure material layer 91B that has been exposed is referred to as a second post-exposure material layer 92B. The second post-exposure material layer 92B includes one or a plurality of second exposed portions 92b that have been exposed and one or a plurality of unexposed portions 93b that have not been exposed. The one or plurality of second exposed portions 92b are cured by exposure.

Next, as shown in FIG. 13, the shielding member 62 shields the emission surface 61a of the exposure device 61 (step S15). In this state, the air knife 71 and the sucker 72 work, and are moved along the upper surface of the second post-exposure material layer 92B on the manufacturing table 31 to a position above the auxiliary table 21. Thus, the one or plurality of unexposed portions 93b are removed (step S16). Thus, the one or plurality of second exposed portions 92b remain. Hereinafter, the remaining one or plurality of second exposed portions 92b are referred to as one or a plurality of second cured portions 94B. At this time, an atmosphere in the stereolithography apparatus 100 may be cleaned by an exhaust fan, an air clean filter unit or the like (not shown). Further, as shown in FIG. 14, the air knife 71 and the sucker 72 clean the auxiliary table 21, and the cup member 42 cleans the recoater 41 (step S17). Next, as shown in FIG. 15, the shielding member 62 releases the shielding of the emission surface 61a of the exposure device 61 (step S18). Thus, the emission surface 61a of the exposure device 61 is uncovered.

In this manner, the n-th cured composition layer 95 is formed on the manufacturing surface 31a or the cured composition layer 95. The cured composition layer 95 includes the one or plurality of first cured portions 94A and the one or plurality of second cured portions 94B. In a case in which n=1, the first cured composition layer 95 is formed on the manufacturing surface 31a. In a case in which n=2 to M, the n-th cured composition layer 95 is formed on the (n−1)-th cured composition layer 95.

When at least one cured composition layer 95 is formed, at least one second exposed portion 92b that has been exposed (at least one second cured portion 94B) is bonded to at least one first cured portion 94A in the same layer or a lower layer by curing. Alternatively, when at least one cured composition layer 95 is formed, at least one first exposed portion 92a that has been exposed (at least one first cured portion 94A) is bonded to at least one second cured portion 94B in a lower layer by curing. That is, different types of materials are bonded by photo-curing.

Thereafter, as shown in FIG. 4, the main control device 81 adds 1 to the value of the variable n (step S19). The main control device 81 determines whether the value of the variable n is larger than the total number M (step S20). In a case in which the value of the variable n is equal to or smaller than the total number M, the main control device 81 returns to the step S3 and repeats the process of the steps S3 to S20. Thus, as shown in FIG. 16, an object SH1 having the stack structure of M (six in the example of FIG. 16) cured composition layers 95 is manufactured. In a case in which the value of the variable n is larger than the total number M in the step S20, the main control device 81 ends the control of the stereolithography apparatus 100.

Note that the order of the process of the steps S1 to S20 may be suitably changed, or a plurality of steps may be performed at the same time. For example, the cleaning of the auxiliary table 21 and/or the recoater 41 in the step S10 can be performed at any time after the step S6 and before the step S12. However, the cleaning of the auxiliary table 21 and/or the recoater 41 is performed so as not to affect the first pre-exposure material layer 91A. For example, a cleaner provided separately from the remover 70 may include a cleaning chamber separated from the space above the manufacturing table 31, and the auxiliary table 21 and/or the recoater 41 may be cleaned in the cleaning chamber.

Thereafter, the object SH1 is degreased and sintered. In the present embodiment, degreasing and sintering are performed at a temperature of about 100 to 2100 degrees. With the above-mentioned operation, the three-dimensional object SH1 formed of a plurality of materials is manufactured. In the present embodiment, a three-dimensional wiring structure including the one or plurality of first cured portions 94A formed of an insulating ceramic material and the one or plurality of second cured portions 94B formed of a conductive material is formed.

### (3) Second Operation Example of Stereolithography Apparatus 100

A second operation example of the stereolithography apparatus 100 will be described. The second operation example of the stereolithography apparatus 100 differs from the first operation example in the following points. FIGS. 17 to 21 are schematic cross sectional views showing part of the second operation example of the stereolithography apparatus 100 of FIG. 1. In the second operation example, after the step of FIG. 10, the steps of FIGS. 17 to 21 are performed instead of the steps of FIGS. 11 to 16.

In the second operation example, after the one or plurality of unexposed portions 93a of the first post-exposure material layer 92A of FIG. 10 in the first operation example are removed, the manufacturing table 31 is lowered such that the distance between the manufacturing surface 31a or the upper surface of the cured composition layer 95, and the lower end of the recoater 41 is Δt+h. Here, h is a value larger than 0.

Next, as shown in FIG. 17, after the recoater 41 is moved to a position above the upper surface of the auxiliary table 21, the recoater 41 draws and spreads the second material 90B from the upper surface of the auxiliary table 21 onto the manufacturing surface 31a or the upper surface of the cured composition layer. In a case in which n=1, the recoater 41 continuously draws and spreads the second material 90B from the upper surface of the auxiliary table 21 onto the manufacturing surface 31a. In a case in which n=2 to M, the recoater 41 continuously draws and spreads the second material 90B on the upper surface of the (n−1)-th cured composition layer 95 from the upper surface of the auxiliary table 21. Hereinafter, the drawn and spread second material 90B is referred to as a second pre-exposure material layer 91B. The second pre-exposure material layer 91B is formed so as to be in contact with the one or plurality of first cured portions 94A. In the present operation example, the second pre-exposure material layer 91B has a second thickness t2 which is larger than the first thickness t1. The size of the second thickness t2 is equivalent to the distance Δt+h. In this case, the second pre-exposure material layer 91B is formed on the manufacturing surface 31a or the upper surface of the cured composition layer 95 so as to cover the one or plurality of first cured portions 94A.

Subsequently, as shown in FIG. 18, the exposure device 61 exposes the second pre-exposure material layer 91B based on the second slice data of the n-th set. Thus, the second post-exposure material layer 92B is formed. The second post-exposure material layer 92B includes one or a plurality of second exposed portions 92b and one or a plurality of unexposed portions 93b. The one or plurality of second exposed portions 92b are cured. In the present operation example, the one or plurality of second exposed portions 92b and the one or plurality of unexposed portions 93b have the second thicknesses t2 larger than the first thicknesses t1.

Next, as shown in FIG. 19, the shielding member 62 shields the emission surface 61a of the exposure device 61. In this state, the air knife 71 and the sucker 72 work, and are moved along the upper surface of the second post-exposure material layer 92B on the manufacturing table 31 to a position above the auxiliary table 21, so that the one or plurality of unexposed portions 93b are removed. Thus, the one or plurality of second exposed portions 92b remain. Hereinafter, the remaining one or plurality of second exposed portions 92b are referred to as one or a plurality of second cured portions 94B. In the present operation example, the one or plurality of second cured portions 94B have the second thickness t2 larger than the first thickness t1. At this time, an atmosphere in the stereolithography apparatus 100 may be cleaned by an exhaust fan, an air clean unit or the like (not shown).

Further, as shown in FIG. 20, the air knife 71 and the sucker 72 clean the auxiliary table 21, and the cup member 42 cleans the recoater 41. In the present embodiment, the remover 70 also serves as a cleaner that cleans the upper surface of the auxiliary table 21. A cleaner may be provided separately from the remover 70. In this case, the cleaner includes an air knife and a sucker, for example, and is controlled by the controller 80. Next, the shielding member 62 releases the shielding of the emission surface 61a of the exposure device 61. Thus, the emission surface 61a of the exposure device 61 is uncovered.

In this manner, the n-th cured composition layer 95 is formed on the manufacturing surface 31a or the cured composition layer 95. The cured composition layer 95 includes the one or plurality of first cured portions 94A and the one or plurality of second cured portions 94B. In a case in which n=1, the first cured composition layer 95 is formed on the manufacturing surface 31a. In a case in which n=2 to M, the n-th cured composition layer 95 is formed on the (n−1)-th cured composition layer 95.

When at least one cured composition layer 95 is formed, at least one second exposed portion 92b that has been exposed (at least one second cured portion 94B) is bonded to at least one first cured portion 94A in the same layer or a lower layer by curing. Alternatively, when at least one cured composition layer 95 is formed, at least one first exposed portion 92a that has been exposed (at least one first cured portion 94A) is bonded to at least one second cured portion 94B in a lower layer by curing. That is, different types of materials are bonded by photo-curing.

As shown in FIG. 21, due to repetition of the above-mentioned process, an object SH2 having the stack structure of M (six in the example of FIG. 16) cured composition layers 95 is manufactured.

### (4) Effects of Embodiments

With the stereolithography apparatus 100 according to the present embodiment, after the first pre-exposure material layer 91A is formed by drawing and spreading of the first material 90A, the one or plurality of first cured portions 94A are formed by exposure and removal. In this case, the first pre-exposure material layer 91A can be formed by simple control of the recoater 41, and the one or plurality of first cured portions 94A can be accurately and highly precisely formed in a predetermined shape by control of light. Further, after the second pre-exposure material layer 91B is formed by drawing and spreading of the second material 90B, the one or plurality of second cured portions 94B are formed by exposure and removal. In this case, the second pre-exposure material layer 91B can be formed by simple control of the recoater 41, and the one or plurality of second cured portions 94B can be accurately and highly precisely formed in a predetermined shape by control of light. As a result, it is possible to highly precisely manufacture the three-dimensional object SH1 formed of different materials without complicating control.

Further, with use of the common auxiliary table 21, the first material 90A can be supplied, the first material 90A can be drawn and spread, the second material 90B can be supplied, and the second material 90B can be drawn and spread. Therefore, complication of the structure of the stereolithography apparatus 100 is reduced, and control of the recoater 41 is simplified.

Further, because the upper surface of the auxiliary table 21 is cleaned after removal of the one or plurality of unexposed portions 93a of the first post-exposure material layer 92A and after removal of the one or plurality of unexposed portions 93b of the second post-exposure material layer 93B, the first material 90A and the second material 90B are prevented from being mixed.

Further, when the one or plurality of unexposed portions 93a, 93b of the first and second post-exposure material layers 92A, 92B are removed, the emission surface 61a of the exposure device 61 is shielded. Therefore, even in a case in which the one or plurality of unexposed portions 93a, 93b that have been removed are scattered as dust, the dust is prevented from adhering to the emission surface 61a of the exposure device 61. Thus, frequency of maintenance and cleaning of the exposure device 61 is reduced.

Further, in the second operation example, when the second pre-exposure material layer 91B is formed by drawing and spreading of the second material 90B, the recoater 41 is prevented from interfering with the upper surface of the first post-exposure material layer 92A. Thus, the allowable range of the movement accuracy of the recoater 41 is relaxed. As a result, it is possible to reduce the cost of the stereolithography apparatus 100. Further, it is possible to easily form the cured composition layer 95 including the first and second cured portions 94A, 94B having different thicknesses.

Further, by adjusting the distance between the manufacturing surface 31a or the upper surfaces of the first and second cured portions 94A, 94B, and the lower end of the spreading member and moving the recoater 41 in parallel to the manufacturing surface 31a, it is possible to easily and accurately form the first pre-exposure material layer 91A having the first thicknesses t1 and the second pre-exposure material layer 91B having the second thicknesses t2.

### (5) Other Embodiments

(5-a) While the objects SH1, SH2 are manufactured with use of two types of materials in the above-mentioned embodiment, an object may be manufactured with use of three or more types of materials. In this case, three or more dispensers storing three or more different types of photocurable materials 90 are provided, for example. After the step of FIG. 15, the steps of FIGS. 11 to 15 are further performed with use of another material. Further, after the step of FIG. 15, the steps of FIGS. 17 to 20 are further performed with use of another material.
(5-b) While the plurality of cured composition layers 95 are formed to have the similar thickness in the above-mentioned embodiment, the present invention is not limited to this. Part or all of the plurality of cured composition layers 95 may be formed to have different thicknesses.
(5-c) While each first pre-exposure material layer 91A and each second pre-exposure material layer 91B are exposed entirely (from the upper surface to the lower surface) in the thickness direction by the exposure device 61 in the above-mentioned embodiment, only part of each first pre-exposure material layer 91A and each second pre-exposure material layer 91B in the thickness direction may be exposed by the exposure device 61. Thus, one or a plurality of exposed portions having thicknesses smaller than the thicknesses of the first pre-exposure material layer 91A or the second pre-exposure material layer 91B can be formed. Thus, the thickness of each cured portion included in each cured composition layer 95 can be arbitrarily adjusted.
(5-d) While the remover 70 includes the air knife 71 and the sucker 72 in the above-mentioned embodiment, the present invention is not limited to this. The remover 70 may include a nozzle that discharges a cleaning liquid (water, alcohol, a surfactant or the like), a nozzle that injects mist of the cleaning liquid, or the like. In this case, in the stereolithography apparatus 100, a collection device for collecting the cleaning liquid may be provided. Further, the remover 70 may include a removal chamber and remove the unexposed portions 93a, 93b in the removal chamber. Further, the remover 70 may be provided separately from the other components of the stereolithography apparatus 100. In this case, a worker may manually move the post-exposure composition layer from the manufacturing table 31 to the remover 70. The remover 70 may be controlled manually by the worker.
(5-e) While the upper surface of the auxiliary table 21 is cleaned by the air knife 71 and the sucker 72 in the above-mentioned embodiment, the present invention is not limited to this. In the stereolithography apparatus 100, a nozzle that discharges a cleaning liquid (water, alcohol, surfactant or the like) for cleaning the upper surface of the auxiliary table 21, a nozzle that injects mist of the cleaning liquid, or the like may be provided separately. In this case, in a case in which the first material 90A and the second material 90B are different from each other, the first material 90A and the second material 90B are sufficiently prevented from being mixed.
(5-f) While each cured composition layer 95 includes a plurality of cured portions formed of a plurality of types of materials in the above-mentioned embodiment, part of the plurality of cured composition layers 95 may include only one or a plurality of cured portions formed of one type of material.
(5-g) While one or a plurality of unexposed portions are removed for each formation of each first post-exposure material layer 92A and each second post-exposure material layer 92B in the above-mentioned embodiment, a plurality of unexposed portions in a plurality of layers may be removed after the formation of a plurality of first post-exposure material layers 92A or after the formation of a plurality of second post-exposure material layers 92B.
(5-h) While a pre-exposure material layer is exposed by scanning of laser light in the above-mentioned embodiment, batch exposure may be performed with use of a plurality of mask members having desired light-transmitting patterns.
(5-i) While a method of manufacturing an object having a three-dimensional wiring structure is described in the above-mentioned embodiment by way of example, the present invention is not limited to this. For example, with use of the stereolithography apparatus 100 according to the above-mentioned embodiment, it is also possible to manufacture a catalytic filter by forming a framework or a structure with a ceramic material or another material and embedding a material having catalysis in the surface of the framework or the structure. In this case, the three-dimensional structuring of the catalytic filter enables improvement of catalytic efficiency. Further, it is also possible to manufacture a piping structure by forming a framework or structure with a metal-based material and coating the surface of the framework or structure with a ceramic material. This piping structure has chemical resistance and corrosion resistance while having the strength of metal.
(5-j) While a photocurable composition including insulating powder and a photocurable composition including conductive powder are used as a photocurable material in the above-mentioned embodiment, the photocurable material is not limited to this. For example, a photocurable composition not including powder may be used as a photocurable material.
(5-k) While a photocurable composition including insulating powder and conductive powder is used as a photocurable material in the above-mentioned embodiment, the powder included in the photocurable composition is not limited to the above-mentioned embodiment. For example, as powder included in a photocurable material, oxides, carbides, borides, nitrides, apatite Cₐ₅ (PO₄)₃(F, Cl, OH)₁, carbon (C), metal and the like may be used. As oxides, zirconia (ZrO₂), yttrium (Y₂O₃), alumina (AL₂O₃), lanthanum oxide (La₂O₃), magnesium oxide (MgO), calcium oxide (CaO), Silicon dioxide (SiO₂), nickel oxide (NiO), copper oxide (CuO), ferrite, barium titanate (BaToO₃), barium zirconate (BaZrO₃), lead zirconate titanate (Pb(Zrx, Til-x)O₃), strontium titanate (SrTiO₃), strontium aluminate, calcium titanate (CaTiO₃), magnesium titanium oxide (MgTiO₃), lanthanum titanate (La₂Ti₂O₇), mullite (Al₆O₁₃Si₂), a borosilicate glass, a complex oxide of these and the like may be used, for example. As carbides, silicon carbide (SiC), tungsten carbide (WC), titanium carbide (TiC) and or the like may be used, for example. As nitrides, aluminum nitride (AlN), silicon nitride (Si₃N₄), boron nitride (BN) and the like may be used, for example. Further, in a case in which a nitride is used in a photocurable composition, a mixture of a nitride and an oxide may be used to facilitate sintering of a photocurable material. As borides, zirconium boride (ZrB₂), magnesium boride (MgB₂) and the like may be used, for example. As metal, a base metal (iron, copper, nickel, aluminum, lead, zinc, tin, tungsten, molybdenum, tantalum, magnesium, cobalt, bismuth, cadmium, titanium, zirconium, antimony, manganese, beryllium, chromium, germanium, vanadium, gallium, hafnium, indium, niobium, thallium, etc.) and a noble metal (gold, silver, platinum, palladium, rhodium, iridium, ruthenium, osmium, rhenium, etc.) may be used, an alloy of two or more types of a base metal and a noble metal may be used, or an intermetallic compound may be used, for example.
(5-l) While each cured composition layer is formed by a syringe method in the above-mentioned embodiment, any layer may be formed by another method such as an inkjet method. While each cured composition layer is formed of a photocurable material in the above-mentioned embodiment, any layer may be formed of another material such as a fused resin.
(5-m) In the above-mentioned embodiment, the first and second materials 90A, 90B are supplied onto the auxiliary table 21, and the first and second materials 90A, 90B on the auxiliary table 21 are drawn and spread on the manufacturing table 31 by the recoater 41. However, the present invention is not limited to this. For example, the first and second materials 90A, 90B may be directly supplied to the end portion of the manufacturing table 31 along the edge 311, and the first and second materials 90A, 90B on the end portion of the manufacturing table 31 may be drawn and spread on the manufacturing table 31 by the recoater 41.

### (6) Reference Embodiment

A stereolithography method of manufacturing an object including one or a plurality of first portions and one or a plurality of cured portions, includes the steps of supplying a photocurable material, forming a pre-exposure material layer by drawing and spreading the photocurable material such that a pre-exposure material layer is formed on a manufacturing surface to be in contact with one or a plurality of first portions formed of a material different from a photocurable material, forming a post-exposure material layer including one or a plurality of exposed portions and one or a plurality of unexposed portions by exposing the pre-exposure material layer, and causing the one or plurality of exposed portions to remain as one or a plurality of cured portions by removing the one or plurality of unexposed portions from the post-exposure material layer.

With this stereolithography method, the pre-exposure material layer is formed so as to be in contact with the first portion by drawing and spreading of the photocurable material. After the pre-exposure material layer is formed, the one or plurality of cured portions are formed by exposure and removal. In this case, with the control for drawing and spreading the photocurable material, the pre-exposure material layer can be formed. With the control of light, the one or plurality of cured portions can be accurately formed in a predetermined shape. As a result, it is possible to highly precisely manufacture a three-dimensional object formed of a plurality of materials without complicating control.

In regard to the stereolithography method, the one or plurality of first portions may have a first thickness and the step of forming the pre-exposure material layer may include drawing and spreading the photocurable material such that the pre-exposure material layer has a second thickness larger than the first thickness.

When the pre-exposure material layer is formed by drawing and spreading, a spreading member is prevented from interfering with the upper surface of the first portion. Thus, the allowable range of the movement accuracy of the spreading member is relaxed. Further, the first portion and the cured portion having different thicknesses can be easily formed.

1. A stereolithography apparatus comprising:
a manufacturing table that has a manufacturing surface;
a supplier that selectively supplies a first material which is a photocurable material and a second material which is a photocurable material different from the first material;
a spreader that forms a first pre-exposure material layer by drawing and spreading the first material supplied by the supplier and forms a second pre-exposure material layer by drawing and spreading the second material supplied by the supplier;
an exposer that forms a first post-exposure material layer including one or a plurality of first exposed portions and one or a plurality of first unexposed portions by exposing the first pre-exposure material layer drawn and spread by the spreader member, and forms a second post-exposure material layer including one or a plurality of second exposed portions and one or a plurality of second unexposed portions by exposing the second pre-exposure material layer drawn and spread by the spreader;
a remover that removes the one or plurality of first unexposed portions and the one or plurality of second unexposed portions from the first and second post-exposure material layers; and
a controller, wherein
the controller
controls the supplier such that the first material is supplied,
controls the spreader such that the first pre-exposure material layer is formed on the manufacturing surface or a cured composition layer formed on the manufacturing surface by spreading of the first material,
controls the exposer such that the first post-exposure material layer including the one or plurality of exposed portions is formed by exposure of the first pre-exposure material layer,
controls the remover such that the one or plurality of first exposed portions remain as one or a plurality of first cured portions by removal of the one or plurality of first unexposed portions from the first post-exposure material layer,
controls the supplier such that the second material is supplied,
controls the spreader such that the second pre-exposure material layer that is in contact with the one or plurality of first cured portions is formed by drawing and spreading of the second material after the one or plurality of first unexposed portions are removed,
controls the exposer such that the second post-exposure material layer including the one or plurality of second exposed portions is formed by exposure of the second pre-exposure material layer, and
controls the remover such that the one or plurality of second exposed portions remain as one or a plurality of second cured portions by removal of the one or plurality of second unexposed portions from the second post-exposure material layer, and
the stereolithography apparatus manufactures an object including the one or plurality of first cured portions and the one or plurality of second cured portions.

2. The stereolithography apparatus according to claim 1, further comprising:
an auxiliary table provided to be capable of being adjacent to the manufacturing table; and
a cleaner that cleans an upper surface of the auxiliary table, wherein
the controller
controls the supplier such that the first material is supplied to the upper surface of the auxiliary table,
controls the spreader such that the first material on the auxiliary table is continuously drawn and spread from the upper surface of the auxiliary table onto the manufacturing surface or the cured composition layer after the first material is supplied,
controls the supplier such that the second material is supplied to the upper surface of the auxiliary table after the first material is drawn and spread,
controls the spreader such that the second material on the auxiliary table is continuously drawn and spread from the upper surface of the auxiliary table onto the manufacturing surface or the cured composition layer after the second material is supplied, and
controls the cleaner such that the upper surface of the auxiliary table is cleaned after the first material is drawn and spread and before the second material is supplied.

3. The stereolithography apparatus according to claim 1, further comprising an auxiliary table provided to be adjacent to the manufacturing table, wherein
the controller
controls the supplier such that the first material is supplied to an upper surface of the auxiliary table,
controls the spreader such that the first material on the auxiliary table is continuously drawn and spread from the upper surface of the auxiliary table onto the manufacturing surface or the cured composition layer after the first material is supplied, and
controls the remover such that the upper surface of the auxiliary table is cleaned after the first material is drawn and spread and before the second material is supplied.

4. The stereolithography apparatus according to claim 1, wherein
the controller
controls the spreading such that the first pre-exposure material layer has a first thickness, and
controls the spread such that the second pre-exposure material layer has a second thickness larger than the first thickness.

5. The stereolithography apparatus according to claim 4, wherein
the spreaders has a lower end extending in parallel with the manufacturing surface, and
the controller
controls the spreader such that the spreader is moved with a distance from the lower end to the manufacturing surface or an upper surface of the cured composition layer maintained equivalent to the first thickness when the first material is drawn and spread, and
controls the spreader such that the spreading is moved with a distance from the lower end to the manufacturing surface or the upper surface of the cured composition layer maintained equivalent to the second thickness when the second material is drawn and spread.

6. The stereolithography apparatus according to claim 1, further comprising a shield that shields the exposer, wherein
the controller controls the shield such that the exposer is shielded when the one or plurality of first unexposed portions are removed and when the one or plurality of second unexposed portions are removed.

7. The stereolithography apparatus according to claim 1, wherein
one of the first or second materials includes an insulating material, and another one of the first or second materials includes a conductive material.

8. A stereolithography method including the steps of:
supplying a first material which is a photocurable material;
forming a first pre-exposure material layer on a manufacturing surface or a cured composition layer formed on the manufacturing surface by drawing and spreading the first material layer;
forming a first post-exposure material layer including one or a plurality of exposed portions by exposing the first pre-exposure material layer;
causing the one or plurality of first exposed portions to remain as one or a plurality of cured portions by removing one or a plurality of first unexposed portions from the first post-exposure material layer;
supplying a second material which is a photocurable material different from the first material;
forming a second pre-exposure material layer that is in contact with the one or plurality of first cured portions by drawing and spreading the second material after the one or plurality of first unexposed portions are removed;
forming a second post-exposure material layer including one or a plurality of second exposed portions by exposing the second pre-exposure material layer; and
causing the one or plurality of second exposed portions to remain as one or a plurality of second cured portions by removing one or a plurality of second unexposed portions from the second post-exposure material layer, wherein
with the optical manufacturing method, an object that includes the one or plurality of first cured portions and the one or plurality of second cured portions is manufactured.

9. The stereolithography method according to claim 8, wherein
the step of forming a first pre-exposure material layer includes forming the first pre-exposure material layer such that the first pre-exposure material layer has a first thickness, and
the step of forming a second pre-exposure material layer includes forming the second pre-exposure material layer such that the second pre-exposure material layer has a second thickness larger than the first thickness.
